(19) United States
(12) Patent Application Publication
(10) Pub. No.: US 2013/0314532 A1
(43) Pub. Date: Nov. 28, 2013

(54) VISION DETECTION DEVICE AND VISION DETECTION METHOD THEREOF

(71) Applicant: Jui-Hsiung KUO, Kaohsiung City (TW)

(72) Inventor: Jui-Hsiung KUO, Kaohsiung City (TW)

(21) Appl. No.: 13/571,172

(22) Filed: Aug. 9, 2012

(30) Foreign Application Priority Data
May 23, 2012 (TW) 101118432

(51) Int. Cl. H04N 7/18

(52) U.S. Cl. 348/135; 348/E07.085

(57) ABSTRACT

The present invention discloses a vision detection device and a vision detection method of the vision detection device provided for a camera to detect a long-range view. The vision detection device comprises a casing, a template, a mirror group and a light-emitting module. The casing comprises a light exit hole. The template is transparent and has a pattern formed on a surface of the template. The mirror group comprises at least three non-planar mirrors. The light-emitting module projects a light beam through the template, and the light beam is then reflected through the mirror group and emitted in form of parallel light to the light exit hole.

### CROSS-REFERENCE TO RELATED APPLICATION

This application claims the benefit of Taiwan Patent Application No. 101118432, filed on May 23, 2012, in the Taiwan Intellectual Property Office, the disclosure of which is incorporated herein in its entirety by reference.

### BACKGROUND OF THE INVENTION

1. Field of the Invention

The present invention relates to a vision detection device for cameras to detect a long range view, and more particularly to the vision detection device and a vision detection method with the features of a small sized device and a high detection accuracy and applicable for detecting a long range view and detecting light beams of different wavebands.

2. Description of Related Art

In general, a close-up lens is installed to an EFA calibration camera installed in a production line or a single lens reflex lens is used to produce a simulated object in an infinitely far environment. However, the close-up lens has the drawback of capturing blurred images, and the single lens reflex lens has the drawbacks of a relatively heavier weight and a relatively higher cost.

With reference to FIG. 1 for a schematic view of a conventional vision detection device, most of the conventional vision devices produce the vision effect by adjusting a lens 13 situated in the middle to allow a camera 14 to detect a long-range view. A light beam is passed through a template 12 and the lens 13 situated in the middle, and the light beam is emitted in form of parallel light to the outside. However, this method is only suitable for light beams with the waveband of a visible light.

Therefore, it is an urgent issue for related designers and manufacturers to design a vision detection device with a small volume and a vision detection method applicable for detecting light beams of different wavebands.

### SUMMARY OF THE INVENTION

In view of the aforementioned problems, it is .a primary objective of the invention to overcome the problems by providing a vision detection device and a vision detection method thereof, wherein the size of the detection device is reduced, and the detection device and method are applicable for detecting light beams of different wavebands.

To achieve the foregoing objective, the present invention provides a vision detection device, applied to a camera for detecting a long-range view, and the vision detection device comprises a casing, a template, a mirror group and a light-emitting module. The casing includes a light exit hole. The template is transparent and has a pattern formed on a surface of the template. The mirror group includes at least three non-planar mirrors. The light-emitting module emits a light beam which is passed through the template, reflected from the mirror group, and emitted in a form of parallel light out of the light exit hole. Wherein, the template, the mirror group and the light-emitting module are installed in the casing, and the camera is aligned towards the light exit hole to detect a long-range view according to the pattern.

Wherein, the mirror group can be a spherical mirror or an aspherical mirror.

Wherein, the light-emitting module emits a visible light, an ultraviolet light or an infrared light.

Wherein, the light beam passes through one of the at least three non-planar mirrors with an included angle being an acute angle.

Wherein, the light beam passes through one of the at least three non-planar mirrors with an included angle being an obtuse angle.

To achieve the foregoing objective, the present invention further provides a vision detection method of a vision detection device, and the vision detection method is applicable for a vision detection device, and the vision detection device comprises a casing, a template, a mirror group and a light-emitting module, and the vision detection method comprises the steps of: setting a light exit hole on a side of the casing; forming a pattern on a surface of the template; installing the mirror group including at least three non-planar mirrors in the casing; installing the template at the front of the light-emitting module; and using the light-emitting module to emit a light beam which is passed through the template, reflected from the mirror group, and emitted in a form of parallel light out of the light exit hole.

In summation, the vision detection device and method of the present invention have one or more of the following advantages:

(1) The vision detection device and method of the present invention provide a smaller device than the conventional detection device for convenience and portability.

(2) The vision detection device and method of the present invention prevents the light path from being hindered or blocked by the installed optical components within a limited space.

(3) The vision detection device and method of the present invention are applicable for detecting light beams of different wavebands, and thus can be used in various kinds of detection such as infrared night vision systems.

### BRIEF DESCRIPTION OF THE DRAWINGS

FIG. 1 is a schematic view of a prior art;

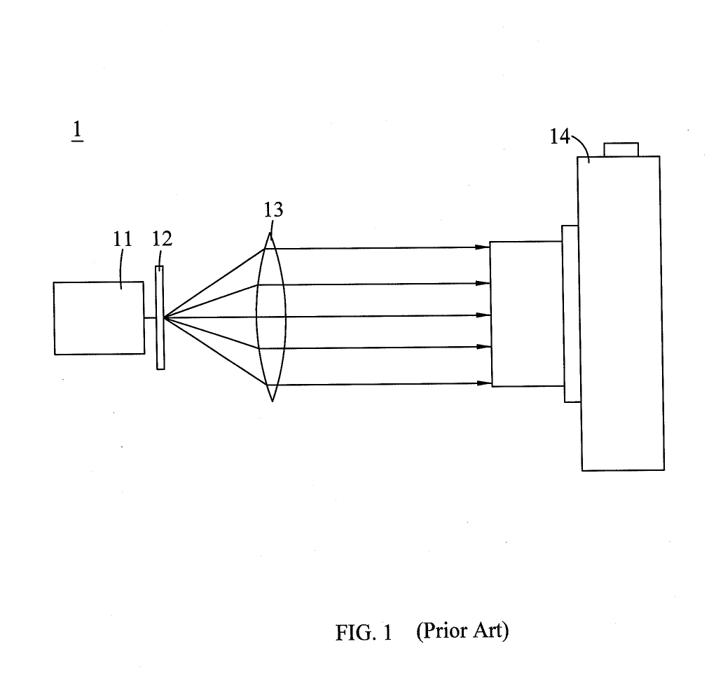

FIG. 2 is a schematic view of a vision detection device in accordance with a first preferred embodiment of the present invention;

FIG. 3 is a schematic view of a vision detection device in accordance with a second preferred embodiment of the present invention; and

FIG. 4 is a flow chart f a vision detection method of the present invention.

### DETAILED DESCRIPTION OF THE PREFERRED EMBODIMENTS

The technical contents and characteristics of the present invention will be apparent with the detailed description of a preferred embodiment accompanied with related drawings as follows. For simplicity, same numerals are used in the following preferred embodiment to represent respective same elements.

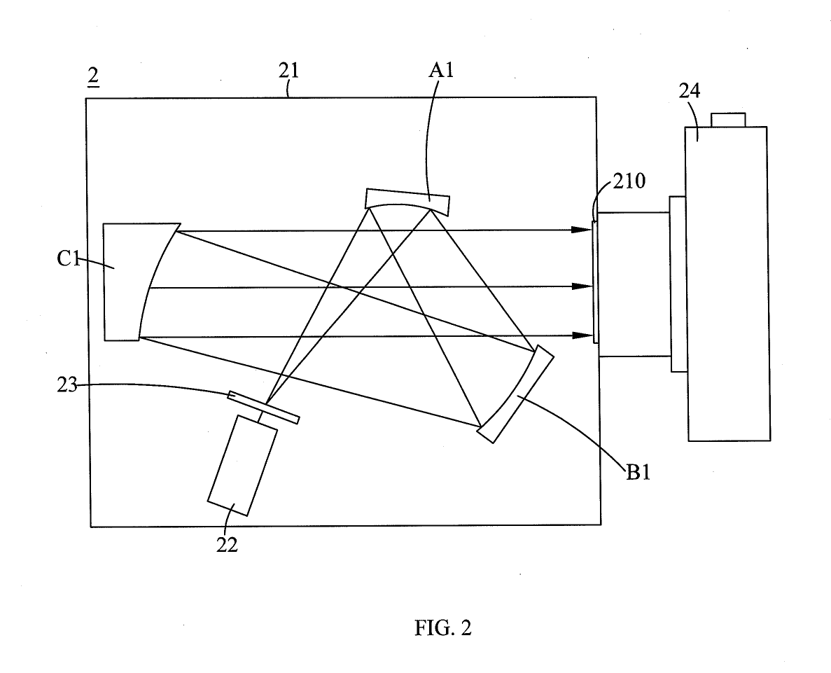

With reference to FIG. 2 for a schematic view of a vision detection device in accordance with the first preferred embodiment of the present invention, the vision detection device 2 is provided for a camera to detect a long-range view, and the vision detection device 2 comprises a casing 21, a template 23, a mirror group (including a mirror A1, a mirror B1 and a mirror C1) and a light-emitting module 22, wherein the template 23, the mirror group and the light-emitting module 22 are installed in the casing 21. The casing 21 includes a light exit hole 210, and a camera 24 is installed at the light exit hole 210. The template 23 is a transparent template 23 and has a pattern formed on a surface of the template 23. The mirror group includes at least three non-planar mirrors, respectively: the mirror A1, the mirror B1 and the mirror C1. The light-emitting module 22 emits a light beam which is passed though the template 23, reflected from the mirror A1, the mirror B1 and the mirror C1, and emitted in form of parallel light out of the light exit hole 210. Wherein, the template 23 is installed at the front of the light-emitting module 22, so that when the light-emitting module 22 emits the light beam, the light beam is passed through the transparent template 23 having the pattern. The mirrors A1, B1 and C1 can be spherical concave mirrors or aspherical concave mirrors, so that the light beam passing through the template 23 is reflected by at least three aspherical mirrors and then projected in the form of the parallel light into the camera 24.

In this preferred embodiment, the light beam passing through one of the three non-planar mirrors with an included angle being an acute angle. In FIG. 2, the light beam emitted from the light-emitting module 22 is passed through the mirror A1 first and then reflected to the mirror B1, and further reflected to the mirror C1, and finally projected in the form of parallel light into the camera 24, The included angle between the incidence and the reflection of the light beam is an acute angle. In other words, the design of the three non-planar mirrors of the present invention can reduce the overall volume of the vision detection device 2 to provide users light and convenient carriage. In addition, the invention can enhance the accuracy and precision of the detection.

It is noteworthy that the aspherical mirrors can reflect the light beam, so that the light-emitting module 22 of the present invention can emit light beams of different wavebands such as a visible light, an ultraviolet light or an infrared light, and the present invention can be applied in a broader range such as the detection in an infrared night vision system.

Based on the first preferred embodiment, a second preferred embodiment of the present invention is further provided as an example of illustrating the invention.

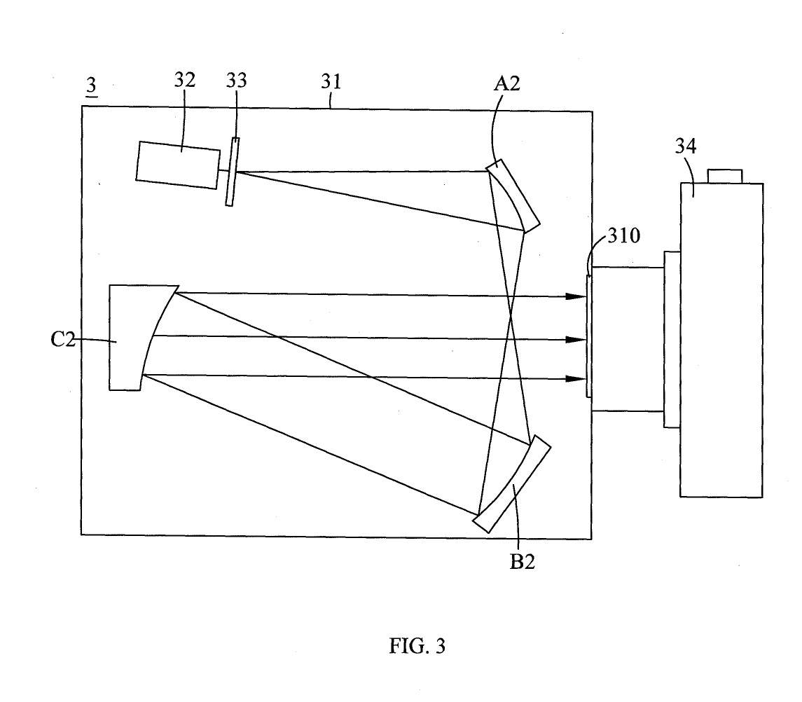

With reference to FIG. 3 for a schematic view of a vision detection device in accordance with the second preferred embodiment of the present invention, the vision detection device 3 comprises a casing 31, a template 33, a mirror group (including a mirror A2, a mirror B2 and a mirror C2) and a light-emitting module 32, wherein the template 33, the mirror group and the light-emitting module 32 are installed in the casing 31. The casing 31 includes a light exit hole 310, and a camera 34 is installed at the light exit hole 310. The template 33 is a transparent template 33 and has a pattern formed on a surface of the template 33. The mirror group includes at least three non-planar mirrors, respectively: the mirror A2, the mirror B2 and the mirror C2. The light-emitting module 32 emits a light beam which is passed through the template 33, reflected from the mirror group, and emitted in form of parallel light out of the light exit hole 310. Wherein, the template 33 is installed at the front of the light-emitting module 32, such that when the light-emitting module 32 emits the light beam, the light beam passes through the transparent template 33 having the pattern. The mirror A2, mirror B2 and mirror C2 are spherical concave mirrors or aspherical concave mirrors, so that the light beam passing through the template 33 can be reflected by the mirror A2, mirror B2 and mirror C2, and then projected in form of parallel light into the camera 34.

In this preferred embodiment, the light, beam passing through one of the three non-planar mirrors with an included angle being an obtuse angle. In FIG. 3, the light beam emitted out of the light-emitting module 32 is passed through the mirror A2 and reflected to the mirror B2, and further reflected to the mirror C2, and finally projected in form of parallel light into the camera.

It is noteworthy that the mirror A2, mirror B2 and mirror C2 can reflect the light beam, so that the light-emitting module 32 of the present invention can emit light beams of different wavebands such as a visible light, an ultraviolet light or an infrared light, and the present invention can be applied in a broader range such as the detection in an infrared night vision system.

It is noteworthy to point out that the size of the template 33 can be reduced, or the template 33 can be replaced to provide more choices to reduce the overall volume of the vision detection device.

Even though the concept of the vision detection method of the vision detection device in accordance with the present invention have been described in the section of the vision detection device, a description of the following flow chart is provided for illustrating the invention more clearly.

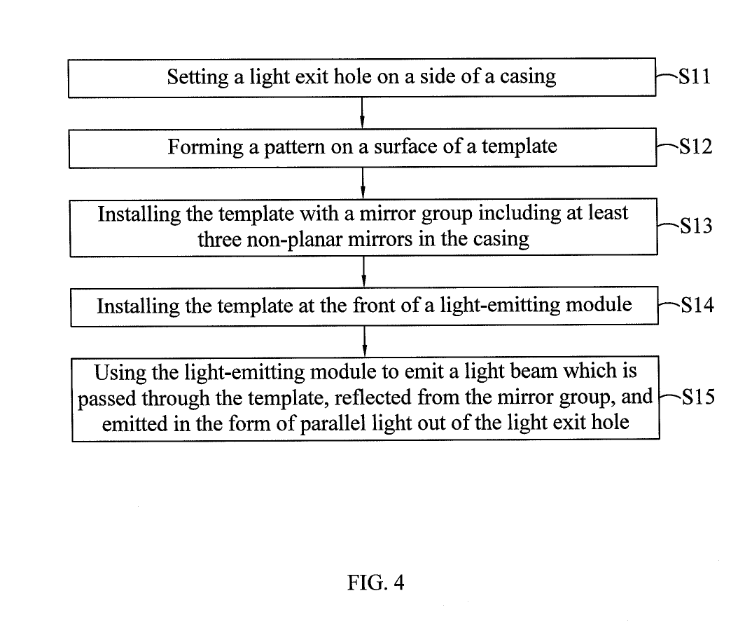

With reference to FIG. 4 for the flow chart of a vision detection method in accordance with the present invention, the vision detection method is applied in a vision detection device which has been described in detail already and will not be repeated, and the vision detection method comprises the following steps:

S11: Setting a light exit hole on a side of a casing.

S12: Forming a pattern on a surface of a template.

S13: Installing the template with a mirror group including at least three non-planar mirrors in the casing.

S14: Installing the template at the front of a light-emitting module.

S15: Using the light-emitting module to emit a light beam which is passed through the template, reflected from the mirror group, and emitted in the form of parallel light out of the light exit hole.

The detailed description and implementation of the vision detection method of the vision detection device in accordance with the present invention have been described in the section of the vision detection device, and thus will not be repeated.

While the invention has been described by means of specific embodiments, numerous modifications and variations could be made by those skilled in the art without departing from the scope and spirit of the invention set forth in the claims.

What is claimed is:

1. A vision detection device, applied to a camera to detect a long-range view, comprising:
a casing, including a light exit hole;
a template, being transparent, and having a pattern formed on a surface of the template;
a mirror group, including at least three non-planar mirrors; and
a light-emitting module, generating a light beam which is passed through the template, reflected from the mirror group, and emitted in a form of parallel light out of the light exit hole;
wherein, the template, the mirror group and the light-emitting module are installed in the casing; and
wherein the camera is aligned towards the light exit hole to detect the long-range view according to the pattern.

2. The vision detection device of claim 1, wherein the mirror group is a spherical mirror or an aspherical mirror.

3. The vision detection device of claim 1, wherein the light-emitting module emits a visible light, an ultraviolet light or an infrared light.

4. The vision detection device of claim 1, wherein the light beam passes through one of the at least three non-planar mirrors with an included angle being an acute angle .

5. The vision detection device of claim 1, wherein the light beam passes through one of the at least three non-planar mirrors with an included angle being an obtuse angle.

6. A vision detection method, applied in a vision detection device, and the vision detection device comprising a casing, a template, a mirror group and a light-emitting module, and the vision detection method comprising the steps of:
setting a light exit hole on a side of the casing;
forming a pattern on a surface of the template;
installing the mirror group including at least three non-planar mirrors in the casing;
installing the template at the front of the light-emitting module; and
using the light-emitting module to emit a light beam which is passed through the template, reflected from the mirror group, and emitted in a form of parallel light out of the light exit hole.

7. The vision detection method of claim 6, further comprising the step of installing the template, the mirror group and the light-emitting module in the casing.

8. The vision detection method of claim 6, wherein the mirror group is a spherical mirror or a aspherical mirror.

9. The vision detection method of claim 6, further comprising the step of using the light-emitting module to emit a visible light, an ultraviolet light or an infrared light.

10. The vision detection method of claim 6, wherein the light beam passes through one of the at least three non-planar mirrors with an included angle being an acute angle.

11. The vision detection method of claim 6, wherein the light beam passes through one of the at least three non-planar mirrors with an included angle being an obtuse angle.
